(19) United States
(12) Patent Application Publication
(10) Pub. No.: US 2006/0237963 A1
(43) Pub. Date: Oct. 26, 2006

(54) Seal for forming a brazed joint

(76) Inventor: Dominick G. More, Middletown, CT (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(21) Appl. No.: 11/408,305

(22) Filed: Apr. 21, 2006

Related U.S. Application Data
(60) Provisional application No. 60/673,522, filed on Apr. 21, 2005.

(51) Int. Cl. F16L 11/12; F16L 17/00

(52) U.S. Cl. 285/49; 277/626

(57) ABSTRACT

A seal (10) for sealing joint (12) between a first metal part (14) and a second metal part (16) of an assembly intended for use at an elevated operating temperature (e.g., greater than 1000° C.). The seal (10) comprises a seal body (50) having a first portion (52), a second portion (54), and a flexible intermediate portion (56) therebetween. A first brazed bond (62) attaches the first portion (52) of the seal body (50) to the first part (14) and a second brazed bond (64) attaches the second portion (54) of the seal body (50) to the second part (16). The flexible intermediate portion (56) functions as hinge allowing the first portion (52) and the second portion (54) to move towards or away from each other thereby accommodating relative movement of the first and second metal parts (14, 16).

### RELATED APPLICATION

This application claims priority under 35 U.S.C. §119 (e) to U.S. Provisional Patent Application No. 60/673,522 filed on Apr. 21, 2005. The entire disclosure of this provisional application is hereby incorporated by reference.

### FIELD OF THE INVENTION

This invention relates generally to a seal for forming a brazed joint and, more particularly, to a seal for forming brazed joint between first and second metal parts of an assembly that is intended for use at an elevated operating temperature.

### BACKGROUND OF THE INVENTION

In a common automotive exhaust system assembly, one or more engine exhaust lines supply hot combustion gasses to a turbocharger. The joint(s) between the turbocharger and the engine exhaust line(s) must be sealed to prevent leakage therefrom. Operating temperatures typically exceed 1000° C. and can be as high as (or higher than) 2000° C., whereby the seals used in these joints must be able to withstand such elevated temperature conditions.

### SUMMARY OF THE INVENTION

The present invention provides a seal which can be used to prevent leakage through a joint between first and second metal parts of an assembly intended for use at an elevated operating temperature (e.g., greater than 1000° C.). The seal can be used in locations whereat welding is not practical and/or possible, does not require expensive ultra-high strength materials, accommodates relative movement between the parts, and/or is forgiving of surface irregularities. Moreover, the seal can be constructed and/or used so that the bonding between the seal and the parts occurs upon initial operation of the assembly thereby simplifying/eliminating seal-installation steps during the manufacture of the assembly.

More particularly, the present invention provides a seal for sealing together a first part (e.g., a metal part) and a second part (e.g., a metal part) of an assembly intended for use at a certain operating temperature. The seal comprises a seal body having a first portion for attachment to the first part and a second portion for attachment to the second part. A braze deposit on the first portion of the seal body, when heated to a brazing temperature, forms a brazed bond to the first part. A braze deposit on the second portion of the seal body, when heated to a brazing temperature, forms a brazed bond to the second part. The brazing temperature will typically be at least 400° C. and often at least 1000° C.

The seal body can further comprise a flexible portion between the first portion and the second portion. This intermediate portion can function as a hinge allowing the first portion and the second portion to move towards or away from each and still maintain a leakproof seal. The seal thus accommodates relative movement between the parts without an increased risk of transient or vibration induced cracking. Additionally or alternatively, the expenses associated with the avoidance of stress relaxation (e.g., costly ultra-high strength materials and/or constant cooling of the seal) are eliminated with the seal of the present invention and the seal body can be made of an economic material (e.g., stainless steel).

To heat the deposits to the brazing temperature, the seal can be indirectly heated by heating the assembled first and second parts. Thus, the seal of the present invention can be used in locations whereat welding and/or soldering would not be practical and/or possible. For example, the seal can be positioned in a groove between confronting faces of the first and second parts, as direct access to the seal is not necessary to create the brazed bonds. It may be further noted that when the braze deposit is heated to a non-solid state, the melted material will flow into any small voids or crevices in the bonding region of the first/second part. Thus, the seal of the present invention is very forgiving of surface irregularities whereby it can afford manufacturers the luxury of loosening surface finish specifications on the to-be-sealed parts.

The braze deposits can be such that they melt at a brazing temperature greater than the operating temperature. Alternatively, the braze deposits can be such that they melt at the operating temperature and thermosettably solidify when subsequently cooled to a temperature below the operating temperature to form the brazed bonds. In the latter case, the brazed bonds can be created upon initial operation of the assembly (e.g., the first time the engine of an automobile is run) and no separate heating step is required during assembly of the parts. Thus, the seal can be provided to the assembler of the parts (with the braze deposits thereon) so that the only installation step required by the assembler is the positioning (manually or automatically) of the seal between first and second parts. This simplification and/or elimination of seal-installation steps would be greatly appreciated in most mass manufacturing arenas (which are essentially the rule without an exception in the automotive industry).

These and other features of the invention are fully described and particularly pointed out in the claims. The following description and annexed drawings set forth in detail certain illustrative embodiments of the invention, these embodiments being indicative of but a few of the various ways in which the principles of the invention may be employed.

### DRAWINGS

FIG. 1 is a schematic view of an automotive exhaust system assembly wherein a seal according to the present invention is installed to seal the joint between a first part and a second part.

FIG. 2 is an enlarged sectional view of the joint between the first and second parts.

FIG. 2A is an enlarged sectional view of the seal and the associated surfaces of the first and second parts.

FIG. 2B is a sectional view similar to FIG. 2A, except that the first and second parts are slightly separated from each other.

FIG. 2C is a close-up of the surface interface between the seal and the first or second part.

FIG. 3 is a sectional view of the seal in a pre-installation condition.

FIGS. 4 and 5 are top/bottom views of the seal in a pre-installation condition, the braze deposit being shown in a continuous distribution in FIG. 4 and in a spaced distribution in FIG. 5.

FIGS. 6A and 6B are sectional schematic views of the seal being installed.

FIGS. 7A-7E are cross-sectional views of other possible versions of the seal, the seal being shown in a pre-installation condition.

### DETAILED DESCRIPTION

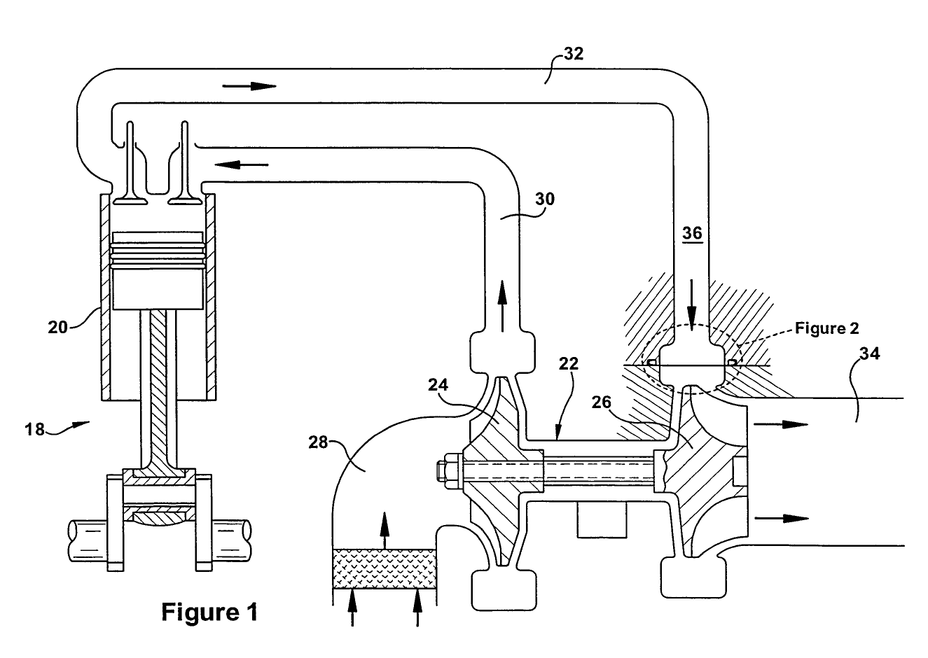

Referring now to the drawings, and initially to FIG. 1, a seal 10 according to the present invention is shown sealing a joint 12 between a first part 14 and a second part 16 in an assembly 18. In the illustrated embodiment, the assembly 18 is an automotive exhaust system assembly comprising an engine 20 and a turbocharger 22 having a compressor 24 and a turbine 26. An air inlet duct 28 supplies air to the compressor-side of the turbocharger 22 and the compressed air flows through an intake pipe 30 from the turbocharger 22 to the engine 20. The exhaust manifold line 32 of the engine 20 supplies hot gas to the turbine-side of the charger 22 and the gas exits the system 18 through an exhaust pipe 34. Operating temperatures in the turbine-side region of the exhaust system 18 typically exceed 1000° C. and can be as high as (or higher than) 2000° C.

In the illustrated embodiment, the first part 14 is an inlet flange of the turbocharger 22 and the second part 16 is an outlet flange of the engine exhaust line 32. Thus, these parts 14/16 will surround a continuous passage 36 carrying a fluid (e.g., engine exhaust gas) and the seal 10 is provided to prevent escape of the fluid from this passage 36 through the joint 12. Typically, the passage 36 in the illustrated and other embodiments will have a circular cross-sectional shape, although such a geometry is certainly not required to reap the benefits of the present invention.

The first part 14 and the second part 16 can be made of the same or different metals which, in the illustrated exhaust system assembly 16, would need to be capable of withstanding a high operating temperature. Suitable metals include, for example, copper, aluminum, or steel. That being said, the seal 10 of the present invention could possibly be used with parts 14/16 made from non-metal high temperature materials (e.g., ceramic, high-temperature plastic, etc.) and/or can be used in assemblies which are not subjected to high operating temperatures.

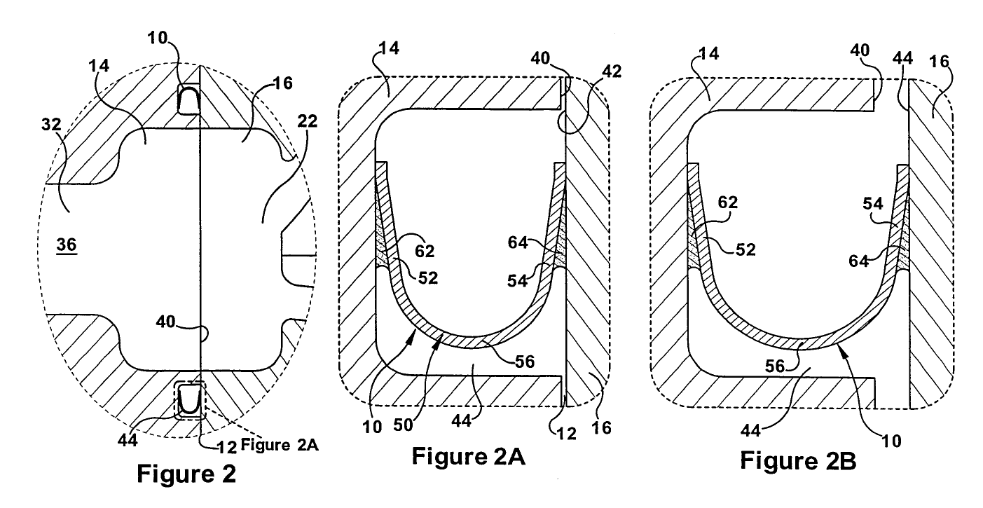

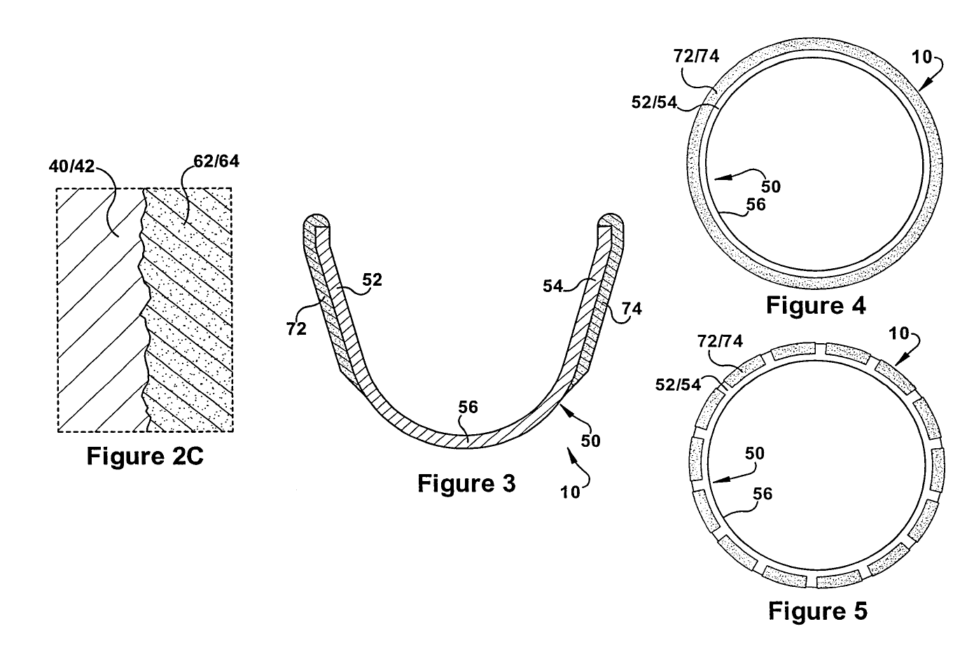

Referring now to FIGS. 2, 2A and 2B, the joint 12 between the first part 14 (the inlet flange of the turbocharger 22) and the second part 16 (the outlet flange of the engine exhaust line 32) is shown. The first and second parts 14 and 16 have confronting faces 40 and 42, respectively, which in the illustrated embodiment, are essentially flat and positioned flush against each other. The seal 10 is positioned in a groove 44 in the confronting face 40 of the first part. It may be noted that welding and/or soldering of the seal 10 in the groove 44 once the faces 40/42 were confronted would not be practical and probably not even possible.

The seal 10 and/or the groove 44 can each have an overall shape which is annular or ring-like to correspond to the geometry of the passage 36 (e.g., circular). In the illustrated embodiment, the groove 44 is formed by a recess in the confronting face 40 of the first part 14 (the inlet flange of the turbocharger 22) and has a rectangular cross-sectional shape. However, a groove 44 formed in the second part 16 or in both parts 14/16, and/or a groove 44 with a different shape, is certainly possible with and contemplated by the present invention.

The seal 10 comprises a body 50 having a first portion 52, a second portion 54, and an intermediate portion 56 therebetween. In the illustrated seal 10, the body 50 has a generally U-shape cross-sectional geometry, with the first portion 52 forming one leg of this U-shape, the second portion 54 forming the other leg of this U-shape, and the intermediate portion 56 occupying the curved union therebetween. The cross-sectional shape of the body 50 need not be U-shape, but is preferably a shape which allows, for reasons articulated below, the intermediate portion 56 to form a hinge between the portions 52 and 54.

The body 50 is made of a material having a melting temperature above that of the expected operating temperature and impermeable to the fluid carried by the passage 36. Suitable seal materials include, for example steel, aluminum, copper. The need for the body material to remain rigid and/or non-flexible at high operating temperatures is thankfully eliminated by the present invention. In fact, in most situations, flexibility of the seal body 50 will be required or at least desired. This flexibility can be accomplished by material selection, cross-sectional shape, and/or cross-sectional size (i.e., thickness).

The seal 10 further comprises a first brazed bond 62 attaching the first portion 52 of the seal body 50 to the first part 14 and a second brazed bond 64 attaching the second portion 54 of the seal body 50 to the second part 16. The brazed bonds 62/64 extend completely around the circumference (or perimeter) of the seal 10. Thus, the first brazed bond 62 forms a leak-proof seam between the first part 14 and the seal body 50 and the second brazed bond 64 forms a leak-proof seam between the second part 16 and the seal body 50.

The brazed bonds 60/62 and, as mentioned above, the seal body 50, are impermeable to the fluid within the passage 36 (e.g., engine exhaust gas). Thus, even if the confronting faces 40/42 of the parts 14/16 were to slightly separate (or otherwise provide gap therebetween), fluid would not escape from the passage 36 to the outside environment. As is best seen in FIG. 2B (wherein the separation between the confronting faces 40/42 has been greatly exaggerated for the purposes of illustration and explanation), the intermediate portion 56 of the seal body 50, if flexible, can function as hinge between the portions 52/54 and allow them to move towards or away from each other. As the parts 14/16 can move relative to each other without over-stressing themselves or the seal 10, the present invention adds life to the assembly 18 and/or reduces the probability of transient or vibration induced cracking. Additionally or alternatively, the ability (and usually the preference) to use a flexible seal body 50 allows expensive ultra-high strength materials to be replaced with lower cost materials (e.g., stainless steel) conventionally considered unsuitable for many high-temperature joint applications because of their susceptibility to stress relaxation.

It may also be noted that the braze bonds 62/64 occupy voids or crevices in the faces 40/42, making the seal 10 of the present invention very forgiving of surface irregularities. (See FIG. 2C, wherein the surface roughness may be greatly exaggerated for the purposes of illustration/explanation.) As such, part manufacturers (e.g., automotive manufacturers) can loosen their surface finish specifications for mating hardware joints which are to be sealed according to the present invention.

Referring now to FIG. 3, the seal 10 is shown prior to installation in the assembly 10. In its pre-installation state (e.g., its shipping state), the seal 10 has a first braze deposit 72 distributed around the outer surface of the first portion 52 of the seal body 50 and a second braze deposit 74 distributed around the outer surface of the second portion 54 of the seal body 50. The braze deposits 72/74 form the brazed bonds 62/64 in the installed seal 10 whereby they can each be distributed in a continuous ring. (See FIG. 4.) However, the important feature is that the brazed bonds 62/64 of the installed seal 10 form leakproof seams in the joint 18. Thus, in some cases, a spaced distribution (probably a closely spaced distribution) may be able to accomplish this objective if, for example, the deposits 72/74 spread during the brazing process and fill in gaps to form a continuous ring. (See FIG. 5.)

The braze deposits 72/74 may comprise any suitable braze material composition such as, for example, gold, silver, nickel, zinc, lead, copper, tin, alloys of these metals and alloys of these metals with other metals, such as phosphorous, cadmium, vanadium and the like. Generally minor amounts of additional components can be included in the braze composition to modify the properties of the bond during and after brazing, such as to modify melting temperature, melt viscosity, abrasive surface wetting and bond strength. The deposits 70/72 can comprise the same or different braze materials. It is noted that when the parts 14 and 16 are made of different metals, the braze material most compatible with the metal of the first part 14 can be selected for the first braze ring 70 and the braze material most compatible with the metal of the second part 16 can be selected for the second braze ring 70.

The application of the braze deposits 72/74 to the seal body 50 can be accomplished in any suitable manner. For example, the portions 52/54 can be coated in a conventional manner with a coating containing the braze material in an evaporating solution. Alternatively, a braze paste can be painted, brushed or otherwise applied to the portions 52/54. If a paste is used, it may be necessary in some instances to temporarily cover the deposits 72/74 with a release liner to prevent undesired adhesion or contamination prior to installation of the seal 10.

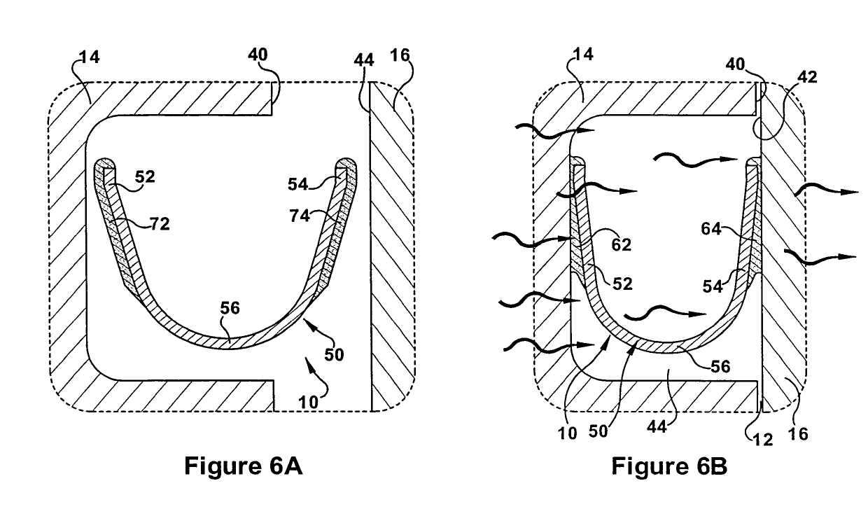

To install the seal 10 in the assembly 16, it is positioned (in a pre-installation state) within the groove 44 and the faces 40/42 of the parts 14/16 are confronted and joined together. (See FIG. 6A.) The parts 14 and 16, in this assembled state, are then heated to a temperature equal to or greater than the brazing temperature of the deposits 72/74. (See FIG. 6B.) This heating results in the deposits 72/74 taking on a liquid or semi-liquid state and flowing to fill the space between portions 52/54 of the seal body 50 and parts 14/16, as well as any voids or crevices in the confronting faces 40/42. (See also FIG. 2C, above.) When the heat is removed and the deposits 72/74 solidify, the formation of the brazed bonds 62/64, and the installation of the seal 10, is complete.

The seal 10 can be provided to the manufacturer in the pre-installation condition shown in FIGS. 3 and 4, and then positioned by the manufacturer between the parts 14/16. No separate step is required to apply the bonding material to the seal 10 and/or the parts 14/16, as would be required with most conventional seal-bonding techniques (e.g., welding or soldering). Prior to the assembly of the parts 14/16, the faces 40/42 can be treated to prepare them for brazing (e.g., an adhesion-enhancing flux material that is activated by the application of heat).

The heating step can be performed in any suitable manner. For example, the parts 14/16 can be locally heated by a torch or other means prior to (or after) their assembly with the other components of the exhaust system 18. Alternatively, the assembled parts 14/16 can be placed in a furnace. However, one advantage of the present invention is that the heating of the braze deposits 72/74 can be accomplished during the first operational temperature transient of the equipment. For example, in the illustrated automotive exhaust system assembly 18, the heating/brazing could occur during the initial run of the engine. If a first-operation heating process is used, the brazing material should be a thermoset type so that it remains solidified during subsequent engine runs or other high-temperature situations. Additionally or alternatively, a dual-melt brazing material can be used so that a lower melting point element goes into solution in the part material and leaves a higher melting point element in place.

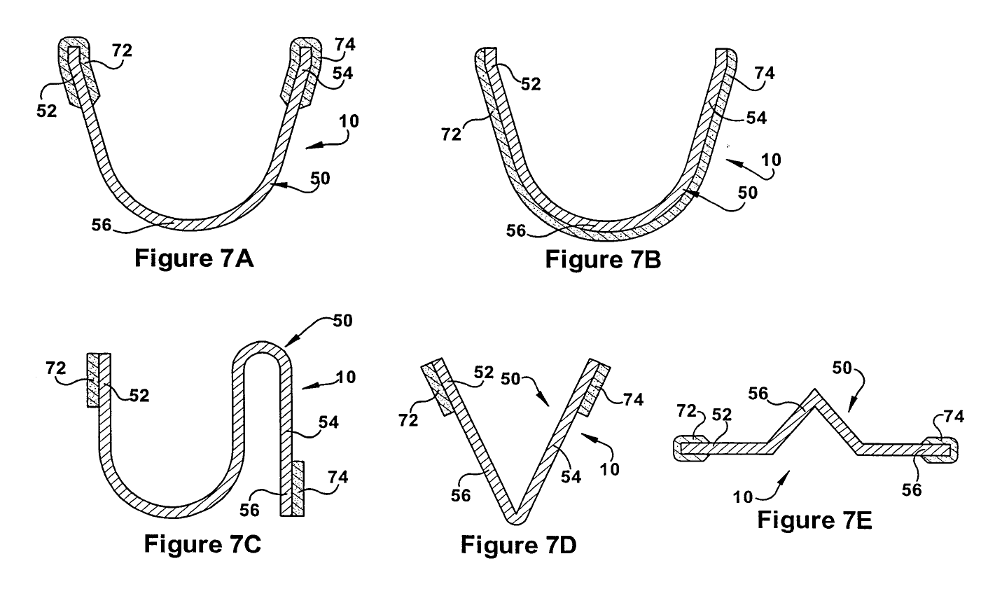

Referring now to FIGS. 7A-7E, other possible versions of the seal 10 are shown. In the seal 10 shown in FIGS. 2-8, the seal body 50 has a U-shaped cross sectional geometry and the braze deposits 72/74 cover the upper regions of the outer surface of the portions 52/54. As shown in FIG. 7A, the braze deposits 72/74 could cover both the inner and outer surfaces of these portions if, for example, the deposits 72/74 are formed by dipping the seal body 50 “legs-first” into the braze composition. As shown in FIG. 7B, the braze deposits 72/74 could collectively occupy the entire outer surface of the seal body 50 if different depositing techniques (e.g., dipping the seal body 50 “legs-last” into the braze composition, spraying the braze composition onto the seal body 50, etc). In the latter case, more care may have to be taken so that the intermediate portion 56 will not inadvertently directly bond to the part 14/16 (e.g., a side wall of the groove 44 in the illustrated embodiment) and thereby prevent expansion of the seal 10. In either or any case, the deposits 72/74 can be continuously or intermittently distributed about the circumference (or perimeter) of the seal body 50. (See FIGS. 5 and 6.)

Also, as shown in FIGS. 7C-7E, the cross-sectional geometry of the seal body 50 need not be U-shape and can instead have a sideways-S-shape, a Z-shape, or even a kinked linear shape. If the intermediate portion 56 is to function as a hinge, any suitable shape allowing movement between the first portion 52 and the second portion 54 can be used. To the extent that the deposits 72/74 are shown covering only the outer surfaces of the portions 52/54, they could instead occupy both surfaces (as in FIG. 7A) and/or an entire surface (as in FIG. 7B). With the modified designs, the potential of the intermediate portion 56 inadvertently being connected to the portions 52/54 during the brazing process should be taken into consideration, as this may prevent the seal 10 from functioning a bellow-like manner.

Moreover, if a hinged construction is not necessary in the intended application for the seal 10, the seal shape must merely accommodate the attachment of the first portion 52 to the first part 14 and the attachment of the second part 54 to the second part 16. Also, the attachment of the intermediate portion 56 to the portions 52/54 and/or the parts 14/16 would not be a concern if relative movement between the parts 14/16 is not necessary.

One may now appreciate the present invention provides a seal 10 which can be used to prevent leakage through a joint 12 between first and second parts 14/16 of an assembly 18. Although the invention has been shown and described with respect to certain preferred embodiments, it is apparent that equivalent and obvious alterations and modifications will occur to others skilled in the art upon the reading and understanding of this specification. The present invention includes all such alterations and modifications and is limited only by the scope of the following claims.

1. A seal for sealing together a first part and a second part of an assembly intended for use at an operating temperature, said seal comprising:
a seal body having a first portion for attachment to the first part and a second portion for attachment to the second part;
a first braze deposit on the first portion of the seal body for forming a brazed bond to the first part; and
a second braze deposit on the second portion of the seal body for forming a brazed bond to the second part.

2. A seal as set forth in claim 1, wherein the first braze deposit and the second braze deposit will melt at a brazing temperature of at least 400° C.

3. A seal as set forth in claim 1, wherein the first braze deposit and the second braze deposit will melt at a brazing temperature of at least 1000° C.

4. A seal as set forth in claim 1, wherein the first braze deposit and the second braze deposit melt at the operating temperature and thermosettably solidify when subsequently cooled to a temperature below the operating temperature to form the brazed bonds.

5. A seal as set forth in claim 1, wherein the first braze deposit and the second braze deposit will melt at a brazing temperature greater than the operating temperature.

6. A seal as set forth in claim 1, wherein the seal body further comprises an intermediate portion between the first portion and the second portion, and wherein the intermediate portion functions as a hinge allowing the first portion and the second portion to move towards or away from each other thereby accommodating relative movement of the first and second parts.

7. A seal as set forth in claim 4 wherein the seal body has a U-shape cross-sectional geometry, with the first portion forming a leg of this U-shape, the second portion forming another leg of this U-shape, and the intermediate portion forming a curved union between the legs of this U-shape.

8. A seal as set forth in claim 1, wherein the first braze deposit covers an outer surface of the first portion and the second braze deposit covers an outer surface of the second portion.

9. A seal as set forth in claim 1, wherein the seal body is a unitary body formed in one-piece.

10. A seal as set forth in claim 1, wherein the seal body is a metal body.

11. A seal as set forth in claim 1, wherein the first braze deposit and the second braze deposit will melt at a brazing temperature that is at least 400° C.;
wherein the seal body is a unitary metal body formed in one-piece;
wherein the seal body further comprises an intermediate portion between the first portion and the second portion; and
wherein the intermediate portion is flexible and functions as a hinge allowing the first portion and the second portion to move towards or away from each other thereby accommodating relative movement of the first and second parts.

12. An assembly comprising a first part, a second part, and the seal of claim 1, wherein:
the first portion of the seal body is attached to the first part by the first brazed bond formed from the first braze deposit, this first brazed bond forming a leak-proof seam between the first part and the seal body; and
the second portion of the seal body is attached to the second part by the second brazed bond formed from the second braze deposit, this second brazed bond forming a leak-proof seam between the second part and the seal body.

13. An assembly as set forth in claim 12, wherein the seal is positioned within a groove between the confronting faces of the first and second parts.

14. An assembly as set forth in claim 12, wherein the first part is a metal part and the second part is a metal part.

15. An automotive exhaust system assembly comprising an engine, a turbocharger, an engine exhaust line extending from the engine to the turbocharger, and the seal of claim 1; wherein:
a metal flange of the turbocharger comprises the first part, and a metal flange of the engine exhaust line comprises the second part;
the seal is positioned in a groove between the first part and the second part;
the first braze deposit is heated to form the brazed bond between the first portion of seal body and the first part; and
the second braze deposit is heated to form the brazed bond between the second portion of the seal body and the second part.

16. A method of sealing a joint between confronting faces of a first metal part and a metal second part, said method comprising the steps of:
providing the seal of claim 1 to an assembler of the first metal part and the second metal part;
positioning the seal between the confronting faces of the first part and the second part so that the first braze deposit is situated adjacent the first part and the second braze deposit is situated adjacent the second part;
heating the seal to a brazing temperature causing the first braze deposit to form the first brazed bond between the first portion of the seal body and the first metal part, and causing the second braze deposit to form a second brazed bond between the second portion of the seal body and the second metal part.

17. A method as set forth in claim 16, wherein said heating step essentially consists of operating the assembly at its operating temperature and wherein the brazed bonds thermosettably solidify after said heating step.

18. A method as set forth in claim 17, wherein the operating temperature is at least 1000° C.

19. An assembly comprising a first metal part, a second metal part, and a seal positioned within a groove between confronting faces of the first and second metal parts;
the seal comprising a seal body having a first portion, a second portion, and an intermediate portion therebetween;
the first portion being braze bonded to the confronting face of the first metal part and the second portion being braze bonded to the confronting face of the second metal part; and
the intermediate portion being flexible and functioning as a hinge allowing the first portion and the second portion to move towards or away from each other thereby accommodating relative movement of the first and second metal part.

20. An assembly as set forth in claim 19, further comprising an engine, a turbocharger, and an engine exhaust line between the engine and the turbocharger; wherein the first part is a flange of the turbocharger and the second part is a flange of the engine exhaust line.
